(19) United States
(12) Patent Application Publication
(10) Pub. No.: US 2020/0134384 A1
(43) Pub. Date: Apr. 30, 2020

(54) ABNORMALITY DETECTION DEVICE

(71) Applicant: MITSUBISHI ELECTRIC CORPORATION, Tokyo (JP)

(72) Inventors: Momoyo HINO, Tokyo (JP); Mengxiong WANG, Tokyo (JP); Kazuo SUGIMOTO, Tokyo (JP); Hidetoshi MISHIMA, Tokyo (JP)

(73) Assignee: MITSUBISHI ELECTRIC CORPORATION, Tokyo (JP)

(21) Appl. No.: 16/626,428

(22) PCT Filed: Sep. 14, 2017
(86) PCT No.: PCT/JP2017/033277

§ 371 Date: Dec. 24, 2019

(51) Int. Cl. G06K 9/62; G06T 7/00

(52) U.S. Cl. CPC G06K 9/6262; G06T 2207/20084; G06T 2207/20081; G06T 7/001

(57) ABSTRACT

The learning model building unit (2) builds a learning model for a convolution neural network, by extracting characteristics of abnormality included in a sample image from the convolution neural network using a kernel having a shape corresponding to the shape of the abnormality included in the sample image and by learning the extracted characteristics.

### TECHNICAL FIELD

The present invention relates to an abnormality detection device for acquiring a classification result of abnormality occurring in an abnormality detection object.

### BACKGROUND ART

Image recognition technology by using deep learning has advanced in recent years, and there are cases where image recognition technology is used for inspection work of abnormality occurring in an abnormality detection object such as a tunnel or a road surface.

For example, an abnormality detection device using image recognition technology for abnormality inspection work collects a large amount of image data indicating sample images of wall surfaces of tunnels where abnormality has occurred, and uses this large amount of image data as learning data to build a deep learning model in advance.

When image data indicating an image of a wall surface of a tunnel that is an abnormality detection object is given, the abnormality detection device acquires a classification result of abnormality occurring in the abnormality detection object using the image data and the built deep learning model (see Patent Literature 1, for example).

### CITATION LIST

### Patent Literatures

Patent Literature 1: WO 2016/189764 A

### SUMMARY OF INVENTION

### Technical Problem

Conventional abnormality detection devices build a deep learning model by extracting characteristics of abnormality occurring on wall surfaces of tunnels and learning the characteristics. However, extracted characteristics are limited to characteristics of the abnormal portions, and no characteristics around the abnormal portions are extracted. For this reason, no characteristics around the abnormal portions are learned, but only the characteristics of the abnormal portions are learned. Therefore, there is a disadvantage that in a case where an image includes a portion having closely similar characteristics to those of an abnormal portion, the portion having the closely similar characteristics may be erroneously detected as abnormality.

For example, in a case where abnormality is a crack on a concrete surface, a connecting part of concrete surfaces or a line-shaped graffiti on a concrete surface whose characteristics are closely similar to those of a crack on a concrete surface, may be erroneously detected as abnormality.

The present invention has been made to solve the above-described disadvantages, and it is an object of the present invention to obtain an abnormality detection device capable of avoiding a situation where a portion having closely similar characteristics to those of an abnormal portion is erroneously detected as abnormality, even in a case where an image of an abnormality detection object includes the portion having the closely similar characteristics.

### Solution to Problem

An abnormality detection device according to the present invention includes: a learning model building unit for using, as learning data for a convolution neural network for outputting a classification result of abnormality, image data indicating a sample image including abnormality, thereby building a learning model for the convolution neural network; and an abnormality detecting unit for giving image data indicating an image of an abnormality detection object to the convolution neural network for which the learning model has been built by the learning model building unit, thereby acquiring the classification result of the abnormality output from the convolution neural network, in which the learning model building unit extracts a characteristic of the abnormality included in the sample image from the convolution neural network by using a kernel having a shape corresponding to a shape of the abnormality included in the sample image and learns the extracted characteristic, thereby adjusting the learning model for the convolution neural network.

### Advantageous Effects of Invention

According to the present invention, the learning model building unit extracts a characteristic of abnormality included in a sample image from a convolution neural network by using a kernel having a shape corresponding to a shape of the abnormality included in the sample image and learns the extracted characteristic, thereby adjusts a learning model for the convolution neural network. Therefore, there is an effect of avoiding a situation where a portion having closely similar characteristics to those of the abnormal portion is erroneously detected as abnormality even in a case where the image of the abnormality detection object includes the portion having the closely similar characteristics.

### BRIEF DESCRIPTION OF DRAWINGS

FIG. 1 is a configuration diagram illustrating an abnormality detection device according to a first embodiment of the invention.

FIG. 2 is a diagram illustrating a hardware configuration of the abnormality detection device according to the first embodiment of the invention.

FIG. 3 is a hardware configuration diagram of a computer in a case where the abnormality detection device is implemented by software, firmware, or the like.

FIG. 4 is a flowchart illustrating a processing procedure for learning in a case where the abnormality detection device is implemented by software, firmware, or the like.

FIG. 5 is a flowchart illustrating a processing procedure for detecting abnormality in a case where the abnormality detection device is implemented by software, firmware, or the like.

FIG. 6 is an explanatory diagram illustrating an exemplary CNN.

FIG. 7 is an explanatory diagram illustrating an exemplary first half of a CNN for which a learning model is built by a learning model building unit 2.

FIG. 8 is an explanatory diagram illustrating an exemplary latter half of the CNN for which a learning model is built by the learning model building unit 2.

FIG. 9 is an explanatory diagram illustrating a display example of a classification result of abnormality by a display unit 5.

FIG. 10 is a configuration diagram illustrating an abnormality detection device according to a second embodiment of the invention.

FIG. 11 is a diagram illustrating a hardware configuration of the abnormality detection device according to the second embodiment of the invention.

FIG. 12 is an explanatory diagram illustrating a display example of a classification result of abnormality by a display unit 5 and a user interface 6a included in a classification result correcting unit 6.

FIG. 13 is an explanatory diagram illustrating a classification result for which adjustment has been accepted by the classification result correcting unit 6.

### DESCRIPTION OF EMBODIMENTS

To describe the present invention further in detail, embodiments for carrying out the present invention will be described below with reference to the accompanying drawings.

### First Embodiment

FIG. 1 is a configuration diagram illustrating an abnormality detection device according to a first embodiment of the invention.

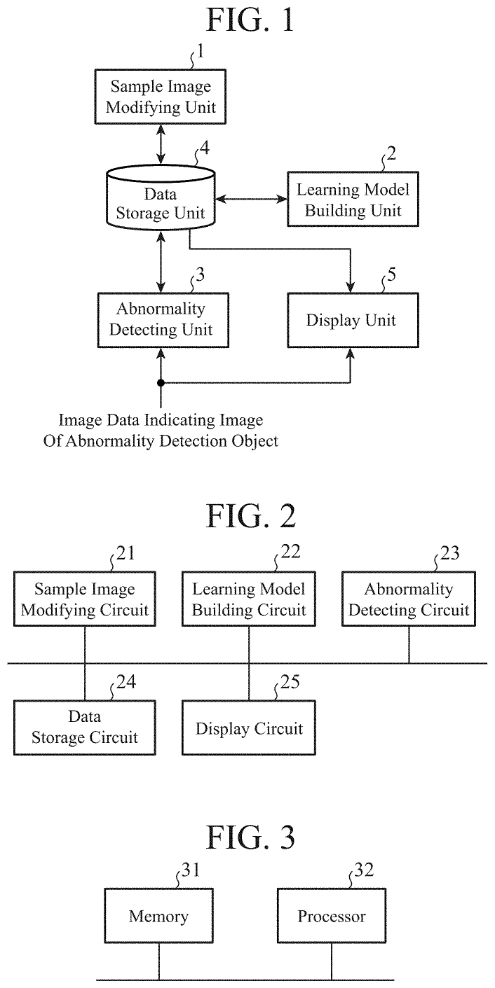

FIG. 2 is a diagram illustrating a hardware configuration of the abnormality detection device according to the first embodiment of the invention.

In FIGS. 1 and 2, a sample image modifying unit 1 is implemented by, for example, a sample image modifying circuit 21 illustrated in FIG. 2.

The sample image modifying unit 1 receives image data, indicating a sample image including abnormality, as learning data for a convolution neural network (CNN) for outputting a classification result of abnormality from a data storage unit 4.

The sample image modifying unit 1 performs, as processing of modifying the sample image and thereby increasing the number of pieces of image data indicating sample images, for example, processing called “data augmentation”, and outputs, to the data storage unit 4, the image data indicating the sample image input thereto and pieces of image data indicating the modified sample images.

The processing called “data augmentation” is processing for obtaining image data indicating a number of sample images, by performing, for example, affine transformation, rotation transformation, illuminance adjustment, or contrast adjustment on image data within a range where characteristics of abnormality included in the image data are not lost.

A learning model building unit 2 is implemented by, for example, a learning model building circuit 22 illustrated in FIG. 2.

The learning model building unit 2 performs processing to build a CNN learning model, by using, as the CNN learning data, the plurality of pieces of image data output from the sample image modifying unit 1 and stored in the data storage unit 4.

The learning model building unit 2 also extracts characteristics of the abnormality included in the sample images from the CNN by using a kernel having a shape corresponding to a shape of the abnormality included in the sample images and learns the extracted characteristics, thereby performing processing of adjusting the CNN learning model.

The learning model building unit 2 outputs the built CNN learning model to the data storage unit 4.

An abnormality detecting unit 3 is implemented by, for example, an abnormality detecting circuit 23 illustrated in FIG. 2.

The abnormality detecting unit 3 performs processing of acquiring a classification result of abnormality that is output from the CNN, by giving image data indicating an image of an abnormality detection object to the CNN having been output from the learning model building unit 2 and stored in the data storage unit 4.

The abnormality detecting unit 3 outputs the acquired classification result of the abnormality to the data storage unit 4.

The data storage unit 4 is implemented by, for example, a data storage circuit 24 illustrated in FIG. 2.

The data storage unit 4 stores image data indicating a sample image, label information indicating the type of abnormality included in the sample image, a learning model for the CNN built by the learning model building unit 2, a classification result of abnormality acquired by the abnormality detecting unit 3, image data indicating sample images output from the sample image modifying unit 1, and other data.

A display unit 5 is implemented by, for example, a display circuit 25 illustrated in FIG. 2.

The display unit 5 performs processing of displaying the classification result of the abnormality stored in the data storage unit 4, the image of the abnormality detection object, and the like.

In FIG. 1, it is assumed that each of the sample image modifying unit 1, the learning model building unit 2, the abnormality detecting unit 3, the data storage unit 4, and the display unit 5 which are components of the abnormality detection device, is implemented by dedicated hardware as illustrated in FIG. 2. That is, it is assumed that implementation is made by the sample image modifying circuit 21, the learning model building circuit 22, the abnormality detecting circuit 23, the data storage circuit 24, and the display circuit 25.

Here, the data storage circuit 24 corresponds to, for example, a nonvolatile or volatile semiconductor memory such as a random access memory (RAM), a read only memory (ROM), a flash memory, an erasable programmable read only memory (EPROM), or an electrically erasable programmable read only memory (EEPROM), a magnetic disc, a flexible disc, an optical disc, a compact disc, a mini disc, or a digital versatile disc (DVD).

The sample image modifying circuit 21, the learning model building circuit 22, the abnormality detecting circuit 23, and the display circuit 25 correspond to, for example, a single circuit, a composite circuit, a programmed processor, a parallel programmed processor, an application specific integrated circuit (ASIC), a field-programmable gate array (FPGA), or a combination thereof.

Note that the components of the abnormality detection device are not limited to those implemented by dedicated hardware, and the abnormality detection device may be implemented by software, firmware, or a combination of software and firmware.

The software or the firmware is stored in a memory of a computer as a program. Here, a computer refers to hardware for executing the program and corresponds to, for example, a central processing unit (CPU), a central processing device, a processing device, an arithmetic device, a microprocessor, a microcomputer, a processor, or a digital signal processor (DSP).

FIG. 3 is a hardware configuration diagram of a computer in a case where the abnormality detection device is implemented by software, firmware, or the like.

In the case where the abnormality detection device is implemented by software, firmware, or the like, it is only required that the data storage unit 4 be configured on a memory 31 of a computer, that a program for causing the computer to execute processing procedures of the sample image modifying unit 1, the learning model building unit 2, the abnormality detecting unit 3, and the display unit 5 be stored in the memory 31, and that a processor 32 of the computer execute the program stored in the memory 31.

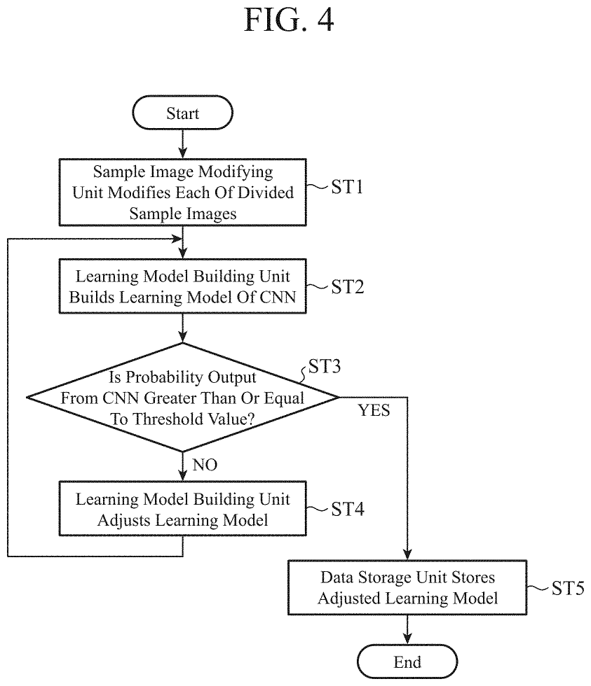

FIG. 4 is a flowchart illustrating a processing procedure for learning in a case where the abnormality detection device is implemented by software, firmware, or the like.

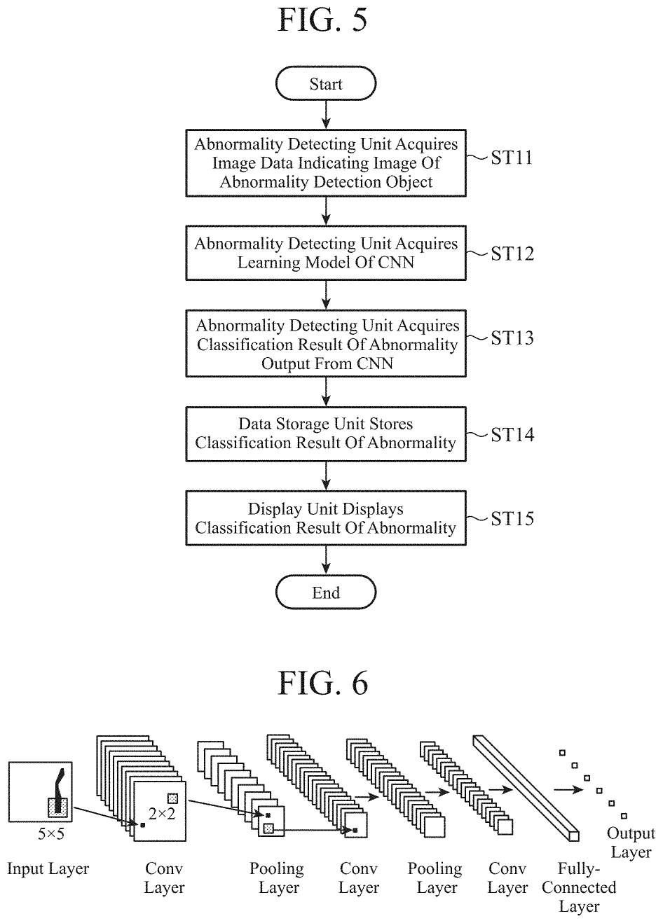

FIG. 5 is a flowchart illustrating a processing procedure for detecting abnormality in a case where the abnormality detection device is implemented by software, firmware, or the like.

FIG. 2 illustrates an example in which each of the components of the abnormality detection device is implemented by dedicated hardware, and FIG. 3 illustrates an example in which the abnormality detection device is implemented by software, firmware, or the like. However, some of the components of the abnormality detection device may be implemented by dedicated hardware and the rest of the components may be implemented by software, firmware, or the like.

Next, the operation will be described.

In the first embodiment, an example will be described in which abnormality detected by the abnormality detection device is abnormality that occurs on a concrete surface as a wall surface of a tunnel.

A concrete surface may crack due to aging in the natural environment, resulting in irregular cracks. Moreover, on the concrete surface, a discoloration portion may appear where the color has changed under the influence of water leakage.

An internal material of the concrete may appear on the concrete surface, as deposits.

Therefore, conceivable abnormality occurring on the concrete surface includes cracks in the concrete surface and discoloration and deposits on the concrete surface.

In the first embodiment, an example will be described in which abnormality occurring on a wall surface of a tunnel is detected. However, it is not limited thereto, and abnormality occurring, for example, on a general structure such as a building or on a road surface, may be detected.

First, the details of processing for building a learning model for the CNN will be described.

A concrete surface that is the wall surface of the tunnel is imaged by a digital camera, for example, and the imaged data of the digital camera is stored in the data storage unit 4 as image data indicating an image of the concrete surface.

In the first embodiment, it is assumed that the image data indicating the image of the concrete surface is RGB data; however, it is not limited thereto, and for example RGB-D data including depth information or light detection and ranging (LiDAR) point group data may be used.

The image data stored by the data storage unit 4 is data indicating a sample image of the concrete surface on which some type of abnormality has occurred.

In the first embodiment, at least image data indicating a sample image of a concrete surface with cracks, image data indicating a sample image of a concrete surface with discoloration, and image data indicating a sample image of a concrete surface on which deposits has appeared are each stored in the data storage unit 4.

Furthermore, label information indicating the types of abnormality occurring on the concrete surface is stored in the data storage unit 4 together with the image data indicating the sample images. The label information is set in advance by a user who has identified the abnormality occurring on the concrete surface.

Incidentally, for convenience of explanation, it is assumed in the first embodiment that image data of a square sample image having an image size of 400×400 is stored in the data storage unit 4. The specified image size of 400×400 represents the number of pixels in the horizontal and vertical directions. Hereinafter, a notation of “OO×AA” represents that “OO” represents the number of pixels in the horizontal direction and that “AA” represents the number of pixels in the vertical direction.

Specifically, in a case where an image data indicating a sample image is RGB data, R data with an image size of 400×400, G data with an image size of 400×400, and B data with an image size of 400×400 are stored in the data storage unit 4.

The sample image modifying unit 1 acquires the image data indicating the sample image stored by the data storage unit 4.

The sample image modifying unit 1 divides the acquired image data indicating the sample image in order to speed up the processing of building a learning model in the learning model building unit 2. For example, image data of a square sample image with an image size of 400×400 is divided into 64 segments to obtain pieces of image data of divided sample images each having an image size of 50×50.

When the sample image modifying unit 1 obtains the pieces of image data of divided sample images, the learning model building unit 2 can handle the image data of divided sample images each having a small image size thereby. This also allows the learning model building unit 2 to simultaneously process the 64 pieces of image data of divided sample images in parallel. Therefore, the learning model building unit 2 can speed up the processing of building a learning model as compared to the case of handling image data indicating a sample image having a large image size.

The sample image modifying unit 1 performs, as processing of modifying each of the divided sample images and thereby increasing the number of pieces of image data indicating divided sample images, for example, processing called “data augmentation” (step ST1 in FIG. 4).

The sample image modifying unit 1 outputs the obtained image data indicating each of the divided sample images and image data indicating each of the modified divided sample images to the data storage unit 4.

It is known that modifying a sample image to increase the number of pieces of image data is useful for improving the building accuracy of a learning model.

The learning model building unit 2 acquires image data indicating a plurality of sample images stored by the data storage unit 4, as learning data for the CNN.

The learning model building unit 2 builds a learning model for the CNN using the acquired image data indicating the plurality of sample images (step ST2 in FIG. 4).

Since the processing for building a learning model for a CNN is known technology, detailed description thereof is omitted.

Here, the CNN will be briefly described.

In order to allow not only characteristics of an abnormal portion but also characteristics of the surroundings of the abnormal portion to be extracted, the CNN includes a layer for extracting characteristics of abnormality included in the divided sample images by using a kernel that is a filter having a smaller size than that of the divided sample images.

FIG. 6 is an explanatory diagram illustrating an exemplary CNN.

As illustrated in FIG. 6, the CNN includes layers such as an input layer, convolutional layers, pooling layers, a fully-connected layer, and an output layer.

The input layer is a layer for receiving the image data of the divided sample image.

A convolutional layer is a layer for extracting characteristics from the divided sample image using a kernel while moving the position of the kernel in the horizontal direction or the vertical direction of the divided sample image, and convolving each of the extracted characteristics.

A pooling layer is a layer for compressing information of the characteristics that has been convolved by the convolutional layer.

The fully-connected layer is a layer for connecting the characteristics that has passed through the pooling layer to each node in the output layer.

The output layer includes, for example, a node indicating a probability that abnormality included in the divided sample image is a crack, a node indicating a probability that the abnormality is discoloration, a node indicating a probability that the abnormality is deposits, and a node indicating a probability that the abnormality is not actually abnormality.

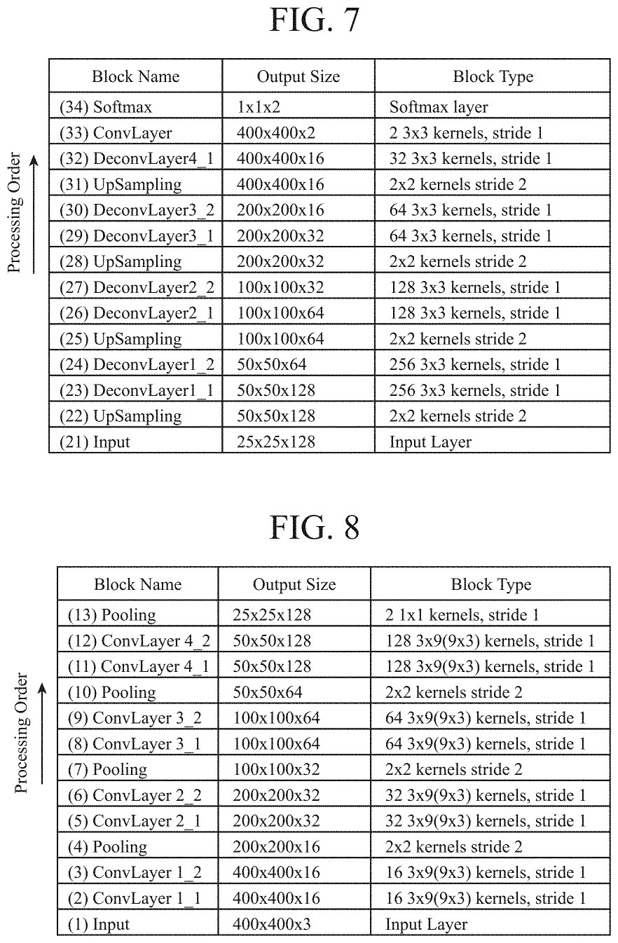

FIG. 7 is an explanatory diagram illustrating an exemplary first half of the CNN for which a learning model is built by the learning model building unit 2.

In FIG. 7, the block name indicates each of layers included in the CNN, the output size indicates the size of data output from each of the layers, and the block type indicates the size of at least one kernel that is a filter or other information.

The first half of the CNN illustrated in FIG. 7 is a downsampling CNN, and in order to detect a crack on the concrete surface as abnormality, an example is illustrated in which a kernel with a size of 3×9 and a kernel with a size of 9×3 are used as rectangular kernels corresponding to linear abnormality.

A rectangular kernel corresponding to linear abnormality is an elongated filter for obtaining a receptive field in the area surrounding the linear abnormality including the area of the linear abnormality, and the size of the kernel is calculated on the basis of the size of the input image data and on the basis of the corresponding layer in the CNN. Since the processing of calculating the kernel size is known technology, detailed description thereof will be omitted.

As the layers of the CNN change with progress in the CNN processing, the range of a receptive field expands.

An arrow in the figure represents the processing order, and Input represents the input layer for receiving image data.

ConvLayer1_1 is a first convolutional layer disposed at the subsequent stage of the input layer and has an output size of 400×400×16.

ConvLayer1_2 is a second convolutional layer disposed at the subsequent stage of ConvLayer1_1 and has an output size of 400×400×16.

ConvLayer1_1 and ConvLayer1_2 use a 3×9 kernel and a 9×3 kernel.

Pooling illustrated in (4) is a first pooling layer disposed at the subsequent stage of ConvLayer1_2, and uses a 2×2 kernel. Since the information of the characteristics that has been convolved by the convolutional layers is compressed in the pooling layer, the output size is reduced to 200×200×16.

ConvLayer2_1 is a third convolutional layer disposed at the subsequent stage of the first pooling layer and has an output size of 200×200×32.

ConvLayer2_2 is a fourth convolutional layer disposed at the subsequent stage of ConvLayer2_1 and has an output size of 200×200×32.

ConvLayer2_1 and ConvLayer2_2 use a 3×9 kernel and a 9×3 kernel.

Pooling illustrated in (7) is a second pooling layer disposed at the subsequent stage of ConvLayer2_2, and uses a 2×2 kernel. Since the information of the characteristics that has been convolved by the convolutional layers is compressed in the pooling layer, the output size is reduced to 100×100×32.

ConvLayer3_1 is a fifth convolutional layer disposed at the subsequent stage of the second pooling layer and has an output size of 100×100×64.

ConvLayer3_2 is a sixth convolutional layer disposed at the subsequent stage of ConvLayer3_1 and has an output size of 100×100×64.

ConvLayer3_1 and ConvLayer3_2 use a 3×9 kernel and a 9×3 kernel.

Pooling illustrated in (10) is a third pooling layer disposed at the subsequent stage of ConvLayer3_2 and uses a 2×2 kernel. Since the information of the characteristics that has been convolved by the convolutional layers is compressed in the pooling layer, the output size is reduced to 50×50×64.

ConvLayer4_1 is a seventh convolutional layer disposed at the subsequent stage of the third pooling layer and has an output size of 50×50×128.

ConvLayer4_2 is an eighth convolutional layer disposed at the subsequent stage of ConvLayer4_1 and has an output size of 50×50×128.

ConvLayer4_1 and ConvLayer4_2 use a 3×9 kernel and a 9×3 kernel.

Pooling illustrated in (13) is a fourth pooling layer disposed at the subsequent stage of ConvLayer4_2 and uses a 1×1 kernel. Since the information of the characteristics that has been convolved by the convolutional layers is compressed in the pooling layer, the output size is reduced to 25×25×128.

The output of Pooling illustrated in (13) is input to Input in the latter half of the CNN illustrated in FIG. 8.

FIG. 8 is an explanatory diagram illustrating an exemplary latter half of the CNN for which a learning model is built by the learning model building unit 2.

The latter half of the CNN illustrated in FIG. 8 is an upsampling CNN, and integrates the characteristics extracted in the first half of the CNN illustrated in FIG. 7. In FIG. 8, as layers in the CNN change, the output size of each of the layers increases.

An arrow in the figure represents the processing order, and Input represents an input layer for receiving the output of Pooling illustrated in (13) in FIG. 7.

Up Sampling illustrated in (22) is a layer disposed at the subsequent stage of the input layer in order to stretch the output of the input layer and has an increased output size of 50×50×128.

DeconvLayer1_1 is a layer disposed at the subsequent stage of UpSampling illustrated in (22), and DeconvLayer1_2 is a layer disposed at the subsequent stage of DeconvLayer1_1.

DeconvLayer1_1 and DeconvLayer1_2 are layers for performing deconvolution using a 3×3 kernel.

UpSampling illustrated in (25) is a layer disposed at the subsequent stage of DeconvLayer1_2 in order to stretch the output of DeconvLayer1_2 and has an increased output size of 100×100×64.

DeconvLayer2_1 is a layer disposed at the subsequent stage of UpSampling illustrated in (25), and DeconvLayer2_2 is a layer disposed at the subsequent stage of DeconvLayer2_1.

DeconvLayer2_1 and DeconvLayer2_2 are layers for performing deconvolution using a 3×3 kernel.

UpSampling illustrated in (28) is a layer disposed at the subsequent stage of DeconvLayer2_2 in order to stretch the output of DeconvLayer2_2 and has an increased output size of 200×200×32.

DeconvLayer3_1 is a layer disposed at the subsequent stage of UpSampling illustrated in (28), and DeconvLayer3_2 is a layer disposed at the subsequent stage of DeconvLayer3_1.

DeconvLayer3_1 and DeconvLayer3_2 are layers for performing deconvolution using a 3×3 kernel.

UpSampling illustrated in (31) is a layer disposed at the subsequent stage of DeconvLayer3_2 in order to stretch the output of DeconvLayer3_2 and has an increased output size of 400×400×16.

DeconvLayer4_1 is a layer disposed at the subsequent stage of UpSampling illustrated in (31).

DeconvLayer4_1 is a layer for performing deconvolution using a 3×3 kernel.

ConvLayer is a layer disposed at the subsequent stage of DeconvLayer4_1.

ConvLayer is a layer for performing convolution using a 3×3 kernel.

Softmax is an output layer disposed at the subsequent stage of ConvLayer, and outputs the probability of being a crack on the concrete surface and the probability of not being a crack on the concrete surface.

For example, when having built a learning model for the CNN as illustrated in FIGS. 7 and 8 to detect a crack on the concrete surface as abnormality, the learning model building unit 2 adjusts the learning model so that the probability of being a crack on the concrete surface that is output from the CNN illustrated in FIG. 8 approaches 1.0 (=100%).

Specifically, the learning model building unit 2 compares the probability of being a crack on the concrete surface that is output from the CNN illustrated in FIG. 8 with a preset threshold value (step ST3 in FIG. 4).

If the probability of being a crack on the concrete surface that is output from the CNN illustrated in FIG. 8 is less than the threshold value (if NO in step ST3 in FIG. 4), the learning model building unit 2 adjusts the learning model so that the probability of being a crack on the concrete surface that is output from the CNN illustrated in FIG. 8 approaches 1.0 (=100%) (step ST4 in FIG. 4).

The learning model building unit 2 adjusts the learning model by, for example, changing a size of the kernel used by each of ConvLayer1-1 and 1-2, ConvLayer2-1 and 2-2, ConvLayer3-1 and 3-2, and ConvLayer4-1 and 4-2 in the CNN as illustrated in FIG. 7.

The following method is conceivable as a method for changing the kernel size.

The learning model building unit 2 refers to label information stored by the data storage unit 4 and recognizes that the abnormality occurring on the concrete surface is a crack in the concrete surface.

Then, the learning model building unit 2 calculates an error between 1.0, indicating that the probability of being a crack on the concrete surface is 100%, and the probability of being a crack that is output from the CNN illustrated in FIG. 8, and calculates, from the calculated error, gradient information indicating a direction in which the kernel is changed.

Note that the processing of calculating the gradient information from the error is well-known technology, and thus detailed description thereof is omitted.

The learning model building unit 2 changes the kernel size in the direction indicated by the calculated gradient information. The amount of change in the kernel size may be a fixed rate or may be calculated from the error.

After adjusting the learning model, the learning model building unit 2 returns to the processing of step ST2, and rebuilds the learning model for the CNN using the adjusted learning model and the image data indicating the acquired plurality of sample images.

The learning model building unit 2 compares the probability of being a crack on the concrete surface that is output from the rebuilt CNN with the preset threshold value (step ST3 in FIG. 4).

If the probability of being a crack on the concrete surface that is output from the rebuilt CNN is less than the threshold value (if NO in step ST3 in FIG. 4), the learning model building unit 2 adjusts the learning model so that the probability of being a crack on the concrete surface that is output from the rebuilt CNN approaches 1.0 (=100%) (step ST4 in FIG. 4).

Thereafter, the processing of steps ST2 to ST4 is repeatedly performed until the probability of being a crack on the concrete surface is greater than or equal to the threshold value.

If the probability of being a crack on the concrete surface that is output from the CNN is greater than or equal to the threshold value (if YES in step ST3 in FIG. 4), the learning model building unit 2 ends the adjustment of the learning model and outputs the adjusted learning model to the data storage unit 4.

The data storage unit 4 stores the learning model output from the learning model building unit 2 (step ST5 in FIG. 4).

Here, an example is illustrated in which the learning model building unit 2 compares the probability of being abnormality with the threshold value and adjusts the learning model when the probability of being abnormality is less than the threshold value.

However, it is not limited thereto. For example, the learning model building unit 2 may compare the number of times of adjustment of the learning model with a preset number of times, and if the number of times of adjustment of the learning model is less than the preset number of times, the learning model building unit 2 may calculate an error therebetween to calculate gradient information from the calculated error and change the kernel size. The learning model building unit 2 ends the adjustment of the learning model when the number of times of adjustment of the learning model reaches the preset number of times.

Furthermore, the example has been illustrated here in which the learning model building unit 2 extracts characteristics of abnormality using a rectangular kernel in order to detect linear abnormality such as cracks on a concrete surface; however, it is not limited thereto.

When abnormality of a plane shape such as deposits or discoloration on a concrete surface is detected, the learning model building unit 2 uses a square kernel such as 4×4 size or 8×8 size to extract characteristics of the abnormality.

Next, the details of processing for detecting abnormality will be described.

For example, when a digital camera images, as an abnormality detection object, a concrete surface that is a wall surface of a tunnel, the abnormality detecting unit 3 acquires the imaging data of the digital camera as image data indicating an image of the abnormality detection object (step ST11 in FIG. 5).

The abnormality detecting unit 3 divides the image of the abnormality detection object indicated by the acquired image data.

For example, the image of the abnormality detection object is divided so that the divided images have the same size as that of the divided sample images obtained from division by the sample image modifying unit 1.

The abnormality detecting unit 3 acquires the learning model for the CNN stored by the data storage unit 4 (step ST12 in FIG. 5).

The abnormality detecting unit 3 obtains a classification result of abnormality output from the CNN by giving image data indicating each of the divided images to the acquired learning model for the CNN (step ST13 in FIG. 5), and outputs the classification result of abnormality to the data storage unit 4.

The data storage unit 4 stores the classification result of the abnormality occurring on the concrete surface of each of the divided images output from the abnormality detecting unit 3 (step ST14 in FIG. 5).

The classification result of the abnormality output from the CNN indicates, for example, the probability for the abnormality occurring on the concrete surface of a divided image being a crack, the probability of being discoloration, the probability of being deposits, or the probability of not being abnormality.

The display unit 5 displays the image of the abnormality detection object on a display.

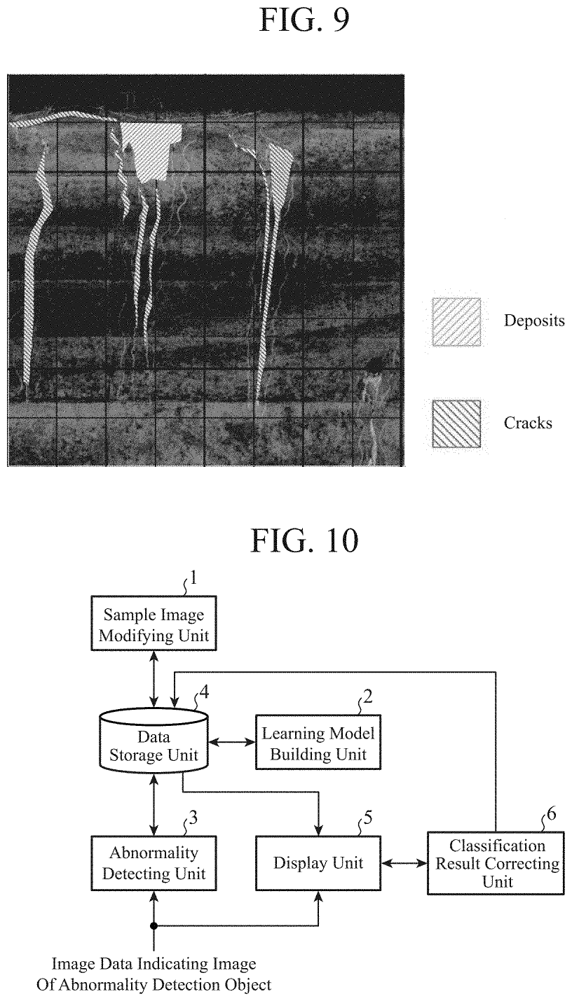

The display unit 5 also acquires the classification result of the abnormality from the data storage unit 4, and displays a classification result of abnormality occurring on the concrete surface of each of the divided images in the image of the abnormality detection object as illustrated in FIG. 9 (step ST15 in FIG. 5).

FIG. 9 is an explanatory diagram illustrating a display example of the classification result of the abnormality by the display unit 5.

In FIG. 9, the abnormality is exemplified by cracks on the concrete surface and deposits on the concrete surface.

As is apparent from the above, according to the first embodiment, the learning model building unit 2 builds the learning model for the convolution neural network, by extracting characteristics of abnormality included in a sample image from the convolution neural network using a kernel having a shape corresponding to a shape of the abnormality included in the sample image, and by learning the extracted characteristics. Therefore, there is an effect of avoiding a situation where a portion having closely similar characteristics to those of the abnormal portion is erroneously detected as abnormality even in a case where the image of the abnormality detection object includes the portion having the closely similar characteristics.

### Second Embodiment

In the first embodiment, the example has been illustrated in which the display unit 5 displays the classification result of abnormality occurring on the concrete surface of each of the divided images.

In a second embodiment, an example will be described in which a classification result correcting unit 6 for accepting correction to a classification result of abnormality displayed by a display unit 5 is further included.

FIG. 10 is a configuration diagram illustrating an abnormality detection device according to the second embodiment of the invention.

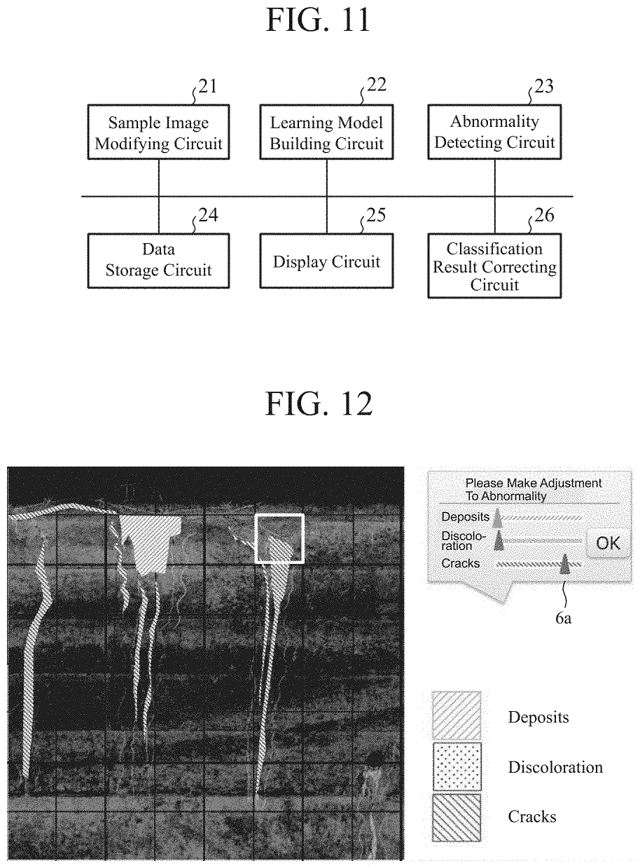

FIG. 11 is a diagram illustrating a hardware configuration of the abnormality detection device according to the second embodiment of the invention.

In FIGS. 10 and 11, the same symbols as those in FIGS. 1 and 2 represent the same or corresponding parts and thus description thereof is omitted.

The classification result correcting unit 6 is implemented by, for example, a classification result correcting circuit 26 illustrated in FIG. 11.

The classification result correcting unit 6 performs processing of accepting correction to a classification result of abnormality displayed by a display unit 5.

In FIG. 10, it is assumed that each of a sample image modifying unit 1, a learning model building unit 2, an abnormality detecting unit 3, a data storage unit 4, the display unit 5, and the classification result correcting unit 6 which are components of the abnormality detection device, is implemented by dedicated hardware as illustrated in FIG. 11. That is, it is assumed that implementation is made by a sample image modifying circuit 21, a learning model building circuit 22, an abnormality detecting circuit 23, a data storage circuit 24, the display circuit 25, and the classification result correcting circuit 26.

Here, the sample image modifying circuit 21, the learning model building circuit 22, the abnormality detecting circuit 23, the display circuit 25, and the classification result correcting circuit 26 may be a single circuit, a composite circuit, a programmed processor, a parallel-programmed processor, an ASIC, an FPGA, or a combination thereof.

Note that the components of the abnormality detection device are not limited to those implemented by dedicated hardware, and the abnormality detection device may be implemented by software, firmware, or a combination of software and firmware.

In the case where the abnormality detection device is implemented by software, firmware, or the like, it is only required that the data storage unit 4 be configured on the memory 31 of the computer illustrated in FIG. 3, that a program for causing the computer to execute processing procedures of the sample image modifying unit 1, the learning model building unit 2, the abnormality detecting unit 3, the display unit 5, and the classification result correcting unit 6 be stored in the memory 31, and that the processor 32 of the computer execute the program stored in the memory 31.

FIG. 11 illustrates an example in which each of the components of the abnormality detection device is implemented by dedicated hardware, and FIG. 3 illustrates an example in which the abnormality detection device is implemented by software, firmware, or the like. However, some of the components of the abnormality detection device may be implemented by dedicated hardware and the rest of the components may be implemented by software, firmware, or the like.

Next, the operation will be described.

In the second embodiment, only the parts different from the first embodiment will be described.

As illustrated in FIG. 12, the display unit 5 displays a classification result of abnormality occurring on a concrete surface of each divided image.

FIG. 12 is an explanatory diagram illustrating a display example, by the display unit 5, of a classification result of abnormality and a user interface 6a included in the classification result correcting unit 6.

The upper right frame in FIG. 12 is the user interface 6a included in the classification result correcting unit 6, and includes slide bars for accepting adjustment to cracks, water leakage, and deposits as abnormality.

Although the user interface 6a illustrated in FIG. 12 is a graphical user interface, the classification result correcting unit 6 also includes a user interface such as a mouse or a keyboard.

Although cracks, discoloration, and deposits are illustrated as legends of abnormality in FIG. 12, since there is no discoloration portion in the example of FIG. 12, there is no classification result indicating that abnormality is discoloration.

In the example of FIG. 12, 64 (=8×8) divided images are displayed.

In the example of FIG. 12, a user determines that the classification result of abnormality for the divided image in the sixth place from the left and the second place from the top (hereinafter referred to as a divided image of (6, 2)) is incorrect, and designates the divided image (6, 2) using the user interface such as the mouse included in the classification result correcting unit 6.

The classification result in the divided image (6, 2) indicates that the abnormality occurring on the concrete surface is a crack.

However, if the abnormality occurring on the concrete surface of the divided image (6, 2) is actually not a crack but deposits, the user adjusts the classification result in the divided image (6, 2) using the slide bar for cracks and the slide bar for deposits.

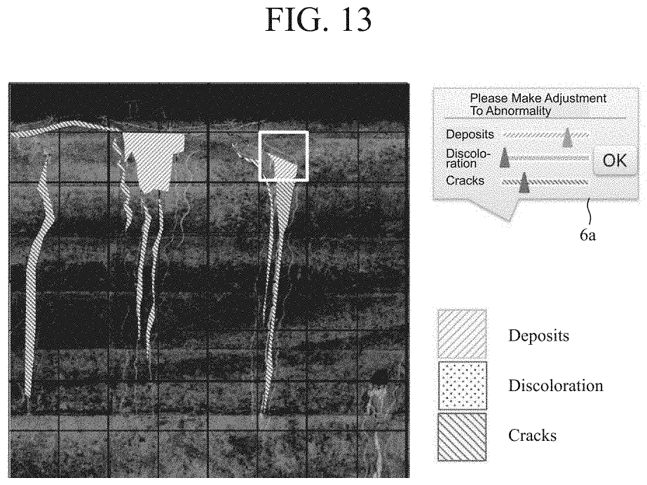

FIG. 13 is an explanatory diagram illustrating a classification result for which adjustment has been accepted by the classification result correcting unit 6.

In the example of FIG. 13, the user slides the symbol of A on the slide bar for cracks to the left to reduce the probability of being a crack, and slides the symbol of A on the slide bar for deposits to the right to raise the probability of being deposits.

The classification result correcting unit 6 accepts the adjustment of the classification result by the user and outputs the corrected classification result to the data storage unit 4.

The data storage unit 4 stores the corrected classification result output from the classification result correcting unit 6.

The learning model building unit 2 can improve the accuracy of the learning model for the CNN, by re-learning using the corrected classification result stored by the data storage unit 4.

The processing of re-learning using the corrected classification result is known technology, and thus detailed description thereof is omitted.

As is apparent from the above, since the second embodiment further includes the classification result correcting unit 6 for accepting correction to a classification result of abnormality displayed by the display unit 5, there is an effect of improving the accuracy of the learning model for the CNN as compared to the above-described first embodiment.

Note that the present invention may include a flexible combination of the embodiments, a modification of any component of the embodiments, or an omission of any component in the embodiments within the scope of the present invention.

### INDUSTRIAL APPLICABILITY

The present invention is suitable as an abnormality detection device for acquiring a classification result of abnormality occurring in an abnormality detection object.

### REFERENCE SIGNS LIST

1: sample image modifying unit, 2: learning model building unit, 3: abnormality detecting unit, 4: data storage unit, 5: display unit, 6: classification result correcting unit, 6a: user interface, 21: sample image modifying circuit, 22: learning model building circuit, 23: abnormality detecting circuit, 24: data storage circuit, 25: display circuit, 26: classification result correcting circuit, 31: memory, 32: processor.

1. An abnormality detection device comprising:
processing circuitry
to use, as learning data for a convolution neural network to output a classification result of abnormality, image data indicating a sample image including abnormality, thereby building a learning model for the convolution neural network; and
to give image data indicating an image of an abnormality detection object to the convolution neural network for which the learning model has been built, thereby acquiring the classification result of the abnormality output from the convolution neural network,
wherein the processing circuitry extracts a characteristic of the abnormality included in the sample image from the convolution neural network by using a kernel having a shape corresponding to a shape of the abnormality included in the sample image and learns the extracted characteristic, thereby adjusting the learning model for the convolution neural network, and
the processing circuitry extracts the characteristic of the abnormality using the kernel having a rectangular shape in a case where the abnormality included in the sample image has a linear shape, and extracts the characteristic of the abnormality using the kernel having a square shape in a case where the abnormality included in the sample image has a plane shape.

2. (canceled)

3. The abnormality detection device according to claim 1, wherein
the processing circuitry modifies the sample image, and
the processing circuitry uses both the image data indicating the sample image and image data indicating the sample image having been modified, as the learning data.

4. The abnormality detection device according to claim 1, wherein the processing circuitry displays the classification result of the abnormality acquired and the image of the abnormality detection object.

5. The abnormality detection device according to claim 4, wherein the processing circuitry accepts correction to the classification result of the abnormality displayed.
